(19) United States
(12) Patent Application Publication
(10) Pub. No.: US 2016/0240018 A1
(43) Pub. Date: Aug. 18, 2016

(54) SYSTEM AND METHOD FOR TRACKING A MOVEABLE ASSET TRANSPORTED BY A VEHICLE

(71) Applicant: WIRELESS LINKS, INC., Lyndhurst, NJ (US)

(72) Inventor: Josef SHAYOVITCH, Hackensack, NJ (US)

(21) Appl. No.: 14/623,917

(22) Filed: Feb. 17, 2015

(51) Int. Cl. G07C 5/00; G01S 19/01; G01S 5/02; H04W 4/00; G06K 7/10

(52) U.S. Cl. CPC G07C 5/008; H04W 4/008; G06K 7/10366; G01S 5/0294; G01S 19/01

(57) ABSTRACT

In a system and method for monitoring location of a moveable asset transported by a vehicle an active RFID tag is mounted in association with the moveable asset and conveys a unique ID to a telematics unit installed in the vehicle when brought into communication range. The telematics unit determines and stored real-time location of the vehicle and the date and time when communication with the RFID tag is established. The telematics unit relays to a remote monitoring center the respective instantaneous location and time of the RFID tag only after the vehicle moves a distance that exceeds the communication range of the RFID tag without the need to install in each moveable asset an expensive telematics unit with associated monthly cellular costs, by taking the GPS location from the telematics unit installed on the vehicle.

### FIELD OF THE INVENTION

This invention relates to asset tracking in general and more particularly to the integration of asset tracking with GPS-based fleet management.

### BACKGROUND OF THE INVENTION

Freight is commonly transported by road in trailers that are conveyed by trucks. In a typical scenario, the trailers are loaded at port or at a depot with merchandise and are then attached to a truck for the purpose of road transportation. When reaching the delivery destination, the trailer is disconnected from the truck, which moves away and leaves the trailer for a few days at the destination to be unloaded. Fleet management systems are used to track in real time the location of the truck and attached trailer.

Such systems are well-known and described, for example, in WO 2014/197497, which discloses geospatial asset tracking systems, methods and apparatus for acquiring, manipulating and presenting telematic metadata. In one configuration, a telematics device is installed in a truck, and another telematics device is installed in the trailer of a large vehicle. Because the truck is generally not permanently attached to or otherwise associated with a given trailer but rather is designed so that the truck can pull any trailer and the trailer is designed to be pulled by any truck, separate telematics devices are used to provide separate points of presence for these two distinct assets.

On connecting the trailer to the truck, the telematics devices of the two vehicles initiate short range communication with each other, enabling the telematics device in the truck to obtain the ID of the trailer, which can then be conveyed in real time to a remote monitoring center. In order for the truck to communicate with the remote monitoring center, the installation of the telematics device in the truck is essential. But the provision of a second telematics device in the trailer is undesirable for a number of reasons. First, there are typically many more trailers than trucks and it is expensive to equip them all with telematics devices. Secondly, much of the time the trailers may be on standby awaiting receipt of a container or other cargo. During this idle time, the telematics devices are not being used and are susceptible to tampering or theft.

Thirdly, telematics devices commonly in use are battery powered units that have integrated GPS receivers and cellular modems and require large batteries. Such devices are expensive, costing several hundred US dollars and are large and require payment of monthly cellular charges.

U.S. Pat. No. 6,753,781 discloses an infant and parent matching and security system and method comprising a dual-mode IR/RF transmitter secured within a wristband worn by the mother and within an ankle and/or wristband worn by the infant. In a matching mode of operation, IR signals are received by infrared receivers located within rooms of the hospital to automatically determine by proximity that mother and infant arc correctly united. In a presence detecting mode, RF signals from the infant's badge are detected by RF receivers located throughout the hospital. In a security mode, RF receivers located proximate exits of either of the maternity ward and/or the hospital detect RF signals from the ankle and provide a signal to generate an alarm.

U.S. Pat. No. 6,574,482 discloses a communication device including an RF transmitter mounted in conjunction with an IR transmitter allowing data to be transmitted by RF as well as by IR. Such a device may be a portable badge worn by moving personnel to transmit IR and RF signals to one of a plurality of second devices each being a fixed reader having an IR and RF receiver, and typically being mounted in a respective enclosed space, such as a room. In use, IR transmissions from the portable device are detected by the IR receiver of the reader in the same room and thus provide an immediate identification of the room (or enclosed space) wherein the portable device is located.

These patents relate to the use of RFID tags for asset tracking where the respective locations of moveable assets or personnel must be individually monitored in real time. In such case, the RFID tags must be constantly active so as to transmit periodic signals to a reader that is fixed in space. By such means the reader tracks movement of the assets and is then able to relay the ID of the associated RFID tag to a monitoring center. By analogy with a fleet management system, the truck corresponds to the reader and tracks the presence of an asset that is brought into proximity thereto. But this is where the analogy ends, because in fleet management tracking systems the truck is not fixed in space.

Since in the above-mentioned patents the reader is fixed, there is no need for a telematics unit at all. The locations of the rooms or security barriers are predetermined and therefore known to the monitoring system, and the location of the moveable asset is tracked relative to these known locations.

This is not the case in fleet management tracking systems where the vehicle itself is constantly moving, which gives rise to the need for a telematics unit in the vehicle capable of determining the vehicle's location in real time. More particularly, within the context of fleet management, assets are commonly tracked using GPS based telematics units that are fixed to or otherwise associated with the moveable assets. Such units are powered by large rechargeable or regular lithium batteries or are solar powered and that have integrated GPS receivers and cellular modems that costs hundreds of dollars and require a cellular network account with a monthly subscription cost of $10-$30.

It would be desirable to provide a fleet management tracking system that obviates the need for telematics devices in the trailers.

### SUMMARY OF THE INVENTION

It is therefore an object of the present invention to provide a system for tracking moveable assets that are transported by a vehicle, which obviates the need for telematics devices to be installed in or bound to the assets.

This object is realized in accordance with a broad aspect of the invention by a system for monitoring location of a moveable asset transported by a vehicle, the system comprising:

an active RFID tag adapted for mounting in association with the moveable asset, said RFID tag having a unique ID and a short-range communications transceiver; and

a telematics unit for installation in association with the vehicle and configured to determine a location in space of the vehicle in real time and having a short-range communications transceiver to effect short range communication with the active RFID tag associated with the moveable asset when the moveable asset is brought into proximity to the vehicle within communication range of the RFID tag so as to determine the ID of the RFID tag and convey the ID and the instantaneous location in space to a remote monitoring center; wherein:

The telematics unit is configured to relay to the remote monitoring center the respective instantaneous location and time of the RFID tag only after the vehicle moves a distance that exceeds the communication range of the RFID tag.

Such a system is distinguished over hitherto-proposed approaches in that it avoids the need to associate a telematics unit with the moveable asset.

Since the telematics unit relays the RFID tag ID and location to the remote monitoring center only after the vehicle moves a distance that exceeds the communication range of the RFID tag, only the last known change in location of an asset is monitored. This avoids the telematics unit falsely relating to assets that are brought within broadcast range but not paired with the telematics unit. Furthermore, while it is being transported, the RFID tag may be dormant thereby saving battery power. Within the context of the description and appended claims, the asset may be a person transported by a vehicle. For example, the system may be used to monitor where and when a child boarded a bus and where and when he/she dismounted. Also, by taking the GPS location from the telematics unit in the vehicle, the invention avoids the need to install in each asset an expensive telematics unit with associated monthly cellular costs.

In some embodiments, communication between the RFID tag and the telematics unit occurs only when the asset is picked up and dropped off whereupon there is instantaneous communication between the RFID tag and telematics unit. When the asset is dropped off and the truck or bus drives away with the telematics unit, there is no real time monitoring of the asset. Preferably, the RFID tag is dormant until brought into or out of proximity with the vehicle thereby conserving the battery in the RFID tag.

In some embodiments, the RFID tag also has a dry contact input so as to monitor and record tampering with a container or trailer with which the RFID tag is associated once the RFID tag is paired with the telematics unit. An alert message is then transmitted via the telematics unit to the monitoring center with the CONNECT location.

In some embodiments, a digital temperature sensor is added to the RF tag to monitor the temperature in refrigerated trailers. Upon pairing the RFID tag to the telematics unit, temperature data is conveyed by the RFID tag to the telematics unit which processes it and compares it to a preset range. If the temperature is out of range, an alert message is then transmitted via the telematics unit to the monitoring center with the actual temperature, and time and location when the out-of-range temperature was measured.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic diagram showing a system according to the invention for monitoring location of a moveable asset transported by a vehicle; and

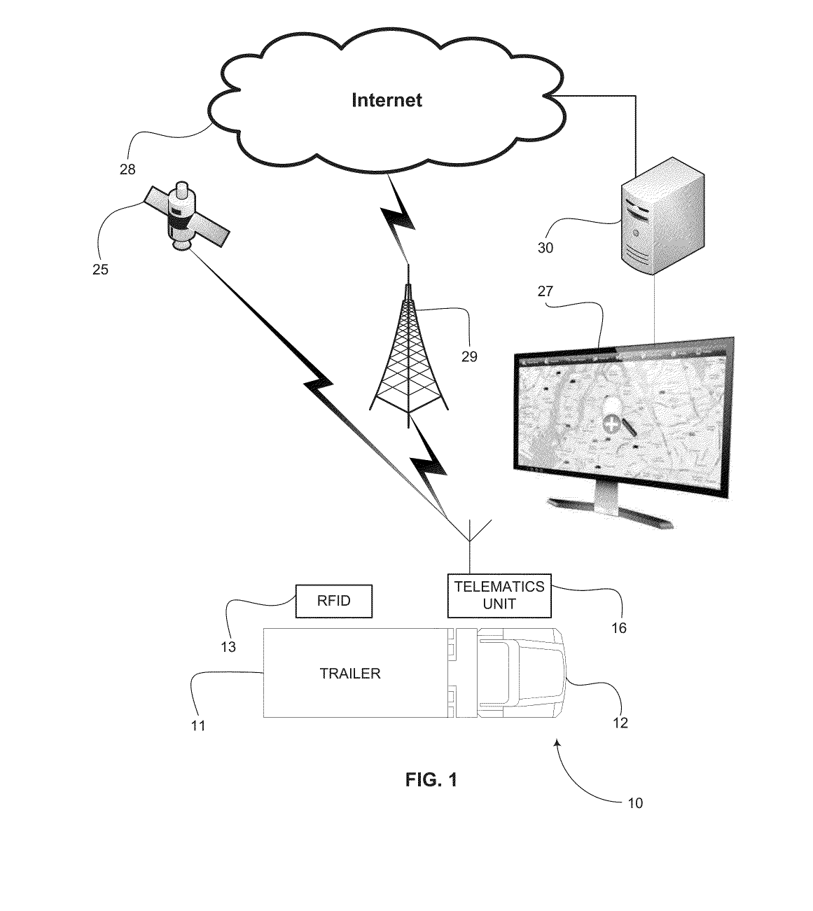

FIGS. 2 and 3 are block diagrams showing the functionality of an RFID tag and a telematics unit used in the system of FIG. 1.

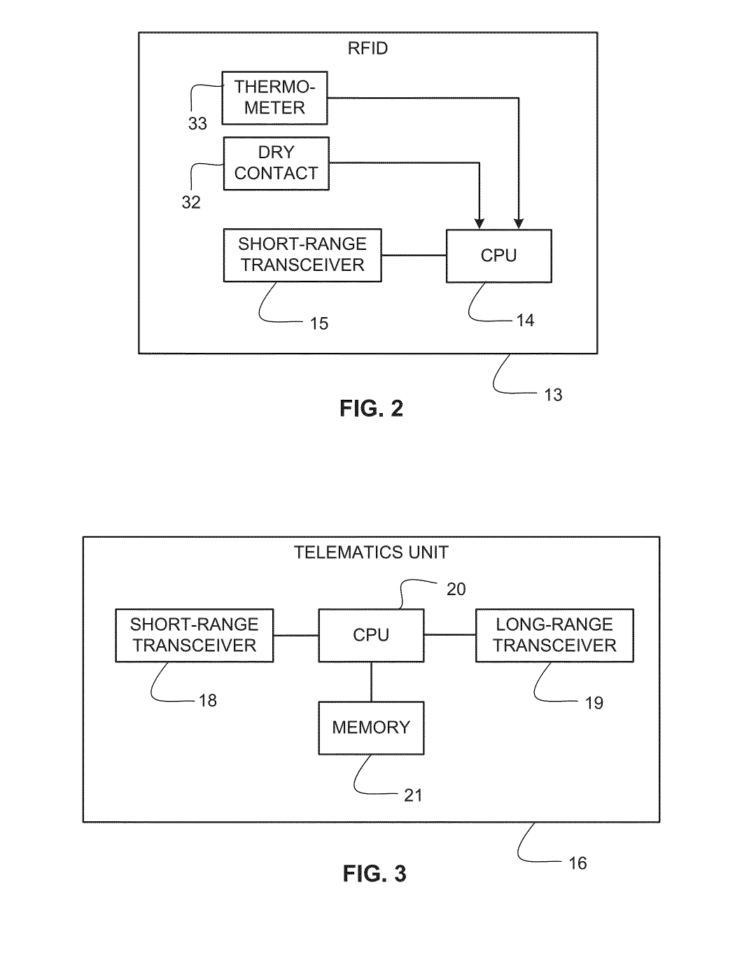

### DETAILED DESCRIPTION OF EMBODIMENTS

Referring to the figures there is shown schematically a system 10 for monitoring location of a trailer 11 constituting a moveable asset transported by a truck 12 constituting a vehicle. The system 10 comprises an active RFID tag 13 having a unique ID adapted for mounting in association with the trailer and having a powerful 32-bit CPU 14 coupled to a short-range communications transceiver 15. Mounted in association with the truck 12 is a telematics unit 16 having a GPS receiver 17, a short-range communications transceiver 18, a long-range transceiver 19 such as cellular and/or WIFI, a processor 20 and a memory 21.

In a preferred embodiment reduced to practice, communication between the RFID tag 13 and the telematics unit 16 is via wireless RF at a frequency of 2.4 GHZ using the IEEE 802.15.4 communication protocol. The communication can be via WIFI, Bluetooth, Zigbi or any other suitable RF channel. The communications protocol can be any standard protocol used in WIFI, ZIGBI or Bluetooth or it can be a proprietary protocol. The design of the RFID tag 13 is based on but not limited to the Jennic JN 5148 Wireless Micro-controller powered by a compact lightweight and low-cost coin 600 mAh lithium cell battery that can power the unit for around 3-5 years without the need to change the battery. In use, the RFID tag 13 requires a short pulse current of milliamps when transmitting. In some embodiments, it may optionally be used in full-duplex mode to receive an acknowledgment from the telematics unit 16 and draws microamperes when listening. The RFID tag 13 has a transmit power in the order of 2.5 DBM and employs a low cost PCB antenna.

At least three GPS satellites 25, only one of which is shown, communicate with the GPS receiver 17 in the telematics unit 16 for determining the respective distances between the GPS receiver 17 and each of the GPS satellites. The GPS receiver 17 computes its location in space using 3-D trilateration based on the three distance measurements it receives from the GPS satellites and their respective locations in space. By such means, the GPS receiver 17 determines a location in space of the truck 12 in real time. The telematics unit 16 also determines the ID of the trailer 11 and via short range communication with the active RFID tag 13 associated therewith the trailer 11 when the trailer is brought into proximity to the truck as well as when it is separated from the truck. The telematics unit 16 transmits via long range communication the ID of the RFID tag and the instantaneous location to a remote monitoring center 27, which is typically adapted for communication with the truck over the Internet 28 via a wireless gateway 29 and a server 30.

In further detail, when the truck 12 picks up the trailer 11 or a container or any other asset that has the RFID tag 13 on it, the RFID tag 13 will pair with the telematics unit 16 that will detect the RFID tag 13 and will forward to the server 30 the message of the form “tag #XX has been detected”. Similarly, when the truck 12 drops off the container or trailer 11 the telematics unit 16 will send a disconnect message to the server 30. The same approach applies for school children, each of whom has an associated RF tag with a unique ID, which may be a badge worn by the child or a tag placed on every child's back pack. Likewise, a telematics unit 16 is installed in every bus and reports to the server 30 the identity of the children who get on and off the bus and at what time.

It is to be noted that no GPS receiver and no cellular modem are required in the RFID tag 13 thus saving much expense and also conserving battery power since these are expensive and consume significant power. Yet the telematics unit 16 will still send to the server 30 not only the date and time of connect/disconnect but also the location that is added to the message by the telematics unit 16. In an actual implementation of the invention reduced to practice, over one-hundred RFID tags can communicate simultaneously with the telematics unit 16. Every “asset” has a system ID according to its associated RFID tag allowing all transported assets to be remotely monitored simultaneously.

In use, every company or fleet must have a unique system ID that is programmed into all the associated RFID tags. In addition every RFID tag has a unique ID that identifies the specific tag and via this ID identifies the specific asset on which the RFID tag is installed. The RFID tag is placed on an asset such as container, trailer or person and continuously sends at regular time intervals e.g. every 10 seconds a ‘keep alive’ signal. The short-range communications transceiver 18 in the telematics unit 16 picks up the ‘keep alive’ signal within a radius of up to around 250 feet (70 meter). Any telematics unit in the specific fleet with the specific unique customer ID can detect any RFID tag within the specific fleet because they all have the same system ID and all adapted to communicate with each other using the same communications protocol.

When a telematics unit 16 detects an RFID tag 13 it will stores the ID in its memory and will send to the server 30 via long range wireless communication the RFID tag's unique ID together with the GPS coordinates, the time and the date when this connection between the RFID tag and the telematics unit was established. For as long as the RFID tag and the telematics unit are within the radius of up to 250 feet they remain connected. Once the truck in which the telematics unit is installed drives away from the asset on which the specific RFID tag is installed, the communication link is broken and a DISCONNECT message with the GPS Location, time and date is sent by the telematics unit 16 to the server 30.

Thus, at any time there might be more than one RFID tag linked to a given telematics unit, there being no defined limit, the process for detecting connection or disconnection for each individual RFID tag being as described above. Here are a few examples:
The truck 12 with installed telematics unit 16 drives into a yard where there are hundreds of containers and/or trailers and or chassis and/or any other asset. As it approaches a given area of the yard where there are say thirty containers 11 within short-range communication, all thirty containers will link up and connect to the telematics unit 16. The telematics unit 16 can be programmed to send the respective IDs of all thirty containers to the server 30 or it can send none of the IDs to the server until the truck drives out of communication range. Once this happens, only the container or trailer or asset 11 it picked up will stay connected and only then will the telematics unit 16 send to the server the ID of the associated RFID tag 13 together with time, date and location of the connect. The location will be the GPS location of the first connection that is stored in the memory 21 of the telematics unit 16. The same process is invoked when the asset is dropped off at a location with no other RFID tags or at a yard where there are many RFID tags. Once the truck drives out of communication range, the communication link between the RFID tag and the telematics unit is broken and the telematics unit 16 will send a disconnect message with location and time stamp to the server 30.
Another example relates to keeping track of children on school buses. Consider the scenario where ten buses pick up 500 children in a schoolyard, i.e. fifty children per bus. Every child has in his back pack an RFID tag, which may simply be placed therein or possible sewn or otherwise secured. At the school yard any RFID tag can link up with the respective telematics unit in any of the ten buses depending on the child's location. The telematics unit picks up and stores the connection data it but it does not send it to the server. When a bus starts to drive away, only the RFID tags for the children that are on this bus remain connected to the telematics unit and only then will the telematics unit send the connection data to the server with the original location first connected. When one or more children get off at a bus stop, once the bus drives away more than 250 feet, the link is broken and the telematics unit will send location data with a time stamp where the children got off the bus.
In order to improve the accuracy of the location associated with the connection and disconnection, the wireless communication range between the RFID tag and the telematics unit can be reduced by setting to any range between 10 feet to 250 feet. The range may be controlled by varying the transmit power of the RFID tag or in the case of using a communication protocol with acknowledgment as described below, the range can be varied by controlling the transmitter output power of the short-range transceiver 18 installed inside the telematics unit 16.

The communication protocol between the RFID tag 13 and the short-range transceiver 18 installed inside the telematics unit 16 can be:
One-way (i.e. single duplex) communication meaning the RFID tag 13 sends a ‘keep alive’ message at predetermined times internals, e.g. every 10 seconds and any telematics unit within the effective range of the RFID tag 13 will receive the message and will link with the tag or tags whereby any given RFID tag can link with more than one telematics unit. This does not matter because once the vehicle drives away, only the RFID tag that stays within the effective range will remain connected.
Two-way (i.e. full duplex) communication meaning the telematics unit 16 detects and links up with the RFID tag and SENDS an Acknowledgment to the RFID tag 13. Once the RFID tag receives the Acknowledgment it will not link up with any other telematics unit, even if it is within the effective range of other telematics units. In this case, the first link that a RFID tag establishes with a telematics unit installed on a truck will block the RFID tag from connecting with any other truck for as long as it stays connected with the first truck.

As opposed to known asset tracking systems where a separate telematics unit is uniquely associated with each asset and sends real time location thereof via GPS, in the system according to the invention only the last known location of an asset or person being tracked is relayed corresponding to the location where and when it was picked up and when and where it was dropped off. Once the asset is dropped off or the child left the bus and the truck or bus drove away, there is no real time monitoring of the disconnected asset or child.

The RFID tag 13 also has an option for a dry contact input 32, whereby if someone tampers with a container or trailer the event is recorded and once the RFID tag 13 is paired with a telematics unit in a truck, a suitable message is sent via the telematics unit with the CONNECT location.

Optionally a digital temperature sensor 33 can be provided in the RFID tag 13 to monitor the temperature of the associated asset. This is particularly applicable to refrigerated trailers, whose temperature is sent to the telematics unit 16 by the RFID tag 13 in the trailer 11 when the trailer is connected to the truck 12. The telematics unit 16 will process it and the temperature is out of range, an alert message is then transmitted via the telematics unit to the server 30 with the actual temperature, and location and time when the out-of-range temperature was measured.

What is claimed is:

1. A system for monitoring location of a moveable asset transported by a vehicle, the system comprising:
an active RFID tag adapted for mounting in association with the moveable asset, said RFID tag having a unique ID and a short-range communications transceiver; and
a telematics unit for installation in association with the vehicle and configured to determine a location in space of the vehicle in real time and having a short-range communications transceiver to effect short range communication with the active RFID tag associated with the moveable asset when the moveable asset is brought into proximity to the vehicle within communication range of the RFID tag so as to determine the ID of the RFID tag and convey the ID and the instantaneous location in space to a remote monitoring center;
wherein:
the telematics unit is configured to relay to the remote monitoring center the respective instantaneous location and time of the RFID tag only after the vehicle moves a distance that exceeds the communication range of the RFID tag.

2. A system for monitoring location of a moveable asset transported by a vehicle, the system comprising:
an active RFID tag adapted for mounting in association with the moveable asset, said RFID tag having a unique ID and a short-range communications transceiver;
a telematics unit for installation in association with the vehicle and configured to determine a location in space of the vehicle in real time and having a short-range communications transceiver to effect short range communication with the active RFID tag associated with the moveable asset when the moveable asset is brought into proximity to the vehicle within communication range of the RFID tag so as to determine the ID of the RFID tag; and
a remote monitoring center configured for long range communication with the telematics unit for receiving therefrom data indicative of an instantaneous location and time and an ID of an RFID tag associated with the vehicle and monitoring movement of the moveable asset associated with RFID tag;
wherein:
the telematics unit is configured to relay to the remote monitoring center the respective instantaneous location and time of the RFID tag only after the vehicle moves a distance that exceeds the communication range of the RFID tag.

3. The system according to claim 2, wherein:
the telematics unit is configured to relay to the remote monitoring center the respective instantaneous location and time of the RFID tag only when the moveable asset boards the vehicle or disembarks therefrom.

4. The system according to claim 2, wherein the RFID tag is dormant until awakened by the telematics unit.

5. The system according to claim 4, wherein the RFID tag is responsive to a request transmitted thereto by the telematics unit for conveying its ID to the vehicle.

6. The system according to claim 5, wherein the telematics unit is configured to transmit the request signal at predetermined time intervals.

7. The system according to claim 2, wherein the RFID tag is dormant until brought into or out of proximity with the vehicle.

8. The system according to claim 2, wherein the RFID tag includes a digital temperature sensor to monitor temperature of the associated moveable asset.

9. The system according to claim 2, wherein the RFID tag includes a temperature sensor for monitoring temperature of the associated asset and for conveying data indicative of the temperature to the telematics unit when in communication range thereof.

10. The system according to claim 9, wherein the telematics unit is adapted to determine whether the temperature is out-of-range and to send an alert message to the monitoring center together with the temperature and location and time when the out-of-range temperature was measured.

11. The system according to claim 2, wherein the RFID tag includes a dry contact input for detecting tampering and for conveying data indicative thereof to the telematics unit when in communication range thereof.

12. The system according to claim 2, wherein a transmit power of the RFID tag is variable.

13. The system according to claim 2, wherein a transmit power of the telematics unit is variable.

14. A method for monitoring location of a moveable asset transported by a vehicle, the method comprising:
mounting an active RFID tag in association with the moveable asset, said RFID tag having a unique ID;
mounting in association with the vehicle a telematics unit configured to determine a location in space of the vehicle in real time to effect short range communication with the active RFID tag associated with the moveable asset when the moveable asset is brought into proximity to the vehicle within communication range of the RFID tag so as to determine the ID of the RFID tag; and
conveying from the telematics unit to a remote monitoring center data indicative of an instantaneous location and time and the ID of the RFID tag associated with the vehicle for allowing remote monitoring of movement of the moveable asset associated with the RFID tag;
wherein:
the telematics unit relays to the remote monitoring center the respective instantaneous location and time of the RFID tag only after the vehicle moves a distance that exceeds the communication range of the RFID tag.

15. The method according to claim 14, wherein the RFID tag is adapted for full duplex communication and the method further includes:
sending an Acknowledgement signal from the telematics to the RFID tag when the asset moves into communication range of the RFID tag; and
disabling the RFID tag from communicating with any other vehicle that comes within communication range of the RFID tag.

16. The method according to claim 14, wherein the RFID tag is dormant until awakened by the telematics unit and the method further includes:
conveying a request from the telematics unit to the RFID tag, and
conveying the ID of the RFID tag from the RFID tag to the telematics unit in response to the request.

17. The method according to claim 14, including:
detecting that the RFID tag is within proximity of the telematics unit;
conveying temperature data from the RFID tag to the telematics unit;
comparing the temperature to a preset range by the telematics unit to log an out-of-range temperature; and
if the temperature is out of range, transmitting an alert message via the telematics unit to the monitoring center with the out-of-range temperature of the moveable asset, and time and location when the out-of-range temperature was measured.

18. The method according to claim 14, including:
reducing the wireless communication range between the RFID tag and the telematics unit in order to improve location accuracy.

19. The method according to claim 18, wherein the range is controlled by varying a transmit power of the RFID tag.

20. The method according to claim 18, wherein:
the RFID is adapted for full duplex communication, and
the range is varied by controlling a transmit power of a short-range transceiver in the telematics unit.
